(19) United States
(12) Patent Application Publication
(10) Pub. No.: US 2024/0389052 A1
(43) Pub. Date: Nov. 21, 2024

(54) IMPROVEMENT FOR 5G NAS SECURITY CONTEXT HANDLING WHEN UE SUPPORTS BOTH 3GPP AND NON-3GPP ACCESSES

(71) Applicant: MediaTek Singapore Pte. Ltd., Singapore (SG)

(72) Inventor: Marko NIEMI, Oulu (FI)

(21) Appl. No.: 18/688,928

(22) PCT Filed: Sep. 7, 2022
(86) PCT No.: PCT/CN2022/117589

§ 371 Date: Mar. 4, 2024

Related U.S. Application Data
(60) Provisional application No. 63/241,110, filed on Sep. 7, 2021.
(60) Provisional application No. 63/340,484, filed on May 11, 2022.

(51) Int. Cl. H04W 60/04; H04W 36/00; H04W 60/06; H04W 84/04

(52) U.S. Cl. CPC H04W 60/04; H04W 36/0038; H04W 60/06; H04W 84/042

(57) ABSTRACT

A method of handling of 5G NAS security context for UEs supporting multiple registrations to different PLMNs over both 3GPP and non-3GPP access types is proposed. The UE should handle the NAS security contexts of the same PLMN similarly, and should handle the NAS security contexts of different PLMNs for different access types independently. If the UE registers to a PLMN over 3GPP or non-3GPP then the security contexts of the PLMN for both 3GPP and non-3GPP are set invalid. If the UE has been registered in a PLMN over 3GPP or non-3GPP and has stored security context for the PLMN and is now deregistered from the PLMN over 3GPP or non-3GPP, the security context of the PLMN becomes valid for both access types.

### CROSS REFERENCE TO RELATED APPLICATIONS

This application claims priority under 35 U.S.C. § 119 from U.S. Provisional Application Number 63/241,110, entitled “5G NAS security context handling when the UE supports both 3GPP and non-3GPP accesses”, filed on Sep. 7, 2021; U.S. Provisional Application No. 63/340,484, entitled “Improvement for handling of 5G NAS security contexts storage for the UE supporting 3GPP and non-3GPP”, filed on May 11, 2022, the subject matter of which is incorporated herein by reference.

### TECHNICAL FIELD

The disclosed embodiments relate generally to wireless communication, and, more particularly, to method of supporting non-access stratum (NAS) security context handling when UE supports both 3GPP and non-3GPP in next generation mobile communication systems.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA, and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. With the optimization of the network design, many improvements have developed over the evolution of various standards. The Next Generation Mobile Network (NGMN) board has decided to focus the future NGMN activities on defining the end-to-end requirements for 5G new radio (NR) systems.

As currently specified in the specification, if the UE is capable of registration over both 3GPP access and non-3GPP access, the UE in the state 5GMM-DEREGISTERED over both 3GPP access and non-3GPP access shall mark the 5G NAS security contexts of the 3GPP access and the non-3GPP access on the USIM or in the non-volatile memory as invalid when the UE initiates an initial registration procedure over either 3GPP access or non-3GPP access or when the UE leaves state 5GMM-DEREGISTERED for any other state except 5GMM-NULL over either 3GPP access or non-3GPP access. Otherwise, the UE shall mark the 5G NAS security context on the USIM or in the non-volatile memory as invalid when the UE initiates an initial registration procedure or when the UE leaves state 5GMM-DEREGISTERED for any other state except 5GMM-NULL.

If the UE is capable of registration over both 3GPP access and non-3GPP access, the UE shall store the current native 5G NAS security contexts of the 3GPP access and the non-3GPP access as specified in annex C and mark them as valid only when the UE enters state 5GMM-DEREGISTERED from any other state except 5GMM-NULL over both the 3GPP access and non-3GPP access or only when the UE aborts the initial registration procedure without having left 5GMM-DEREGISTERED over both the 3GPP access and non-3GPP access. Otherwise, the UE shall store the current native 5G NAS security context as specified in annex C and mark it as valid only when the UE enters state 5GMM-DEREGISTERED from any other state except 5GMM-NULL or when the UE aborts the initial registration procedure without having left 5GMM-DEREGISTERED.

What is currently specified does not consider that the stored security context for 3GPP access maybe for a different PLMN than the stored security context for non-3GPP access, in which case the UE cannot mark both 3GPP and non-3GPP security contexts as invalid, but only the context of the access that registers at the time. Due to unnecessary/incorrect security context invalidation, the UE has to send initial NAS message to network unprotected (plain) (unprotected message is always a security risk) and the network needs to process authentication and security mode control procedures against the UE to establish secure connection causing unnecessary signaling load, unnecessary power consumption.

A solution is sought.

### SUMMARY

A method of handling of 5G NAS security context for UEs supporting multiple registrations to different PLMNs over both 3GPP and non-3GPP access types is proposed. The UE should handle the NAS security contexts of the same PLMN similarly, and should handle the NAS security contexts of different PLMNs for different access types independently. If the UE registers to a PLMN over 3GPP or non-3GPP then the security contexts of the PLMN for both 3GPP and non-3GPP are set invalid. If the UE has been registered in a PLMN over 3GPP or non-3GPP and has stored security context for the PLMN and is now deregistered from the PLMN over 3GPP or non-3GPP, the security context of the PLMN becomes valid for both access types.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary next generation 5G new radio (NR) network that handles 5G NAS security contexts storage for UE supporting both 3GPP access and non-3GPP access in accordance with one novel aspect.

FIG. 2 illustrates simplified block diagrams of a user equipment (UE) and a base station (BS) in accordance with embodiments of the current invention.

FIG. 3 illustrates a first embodiment of a method for 5G NAS security contexts handling when UE registers to different PLMNs over different access in a 5G system in accordance with one novel aspect.

FIG. 4 illustrates a second embodiment of a method for 5G NAS security contexts handling when UE de-registers from different PLMNs over different access in a 5G system in accordance with one novel aspect.

FIG. 5 illustrates a third embodiment of a method for 5G NAS security contexts handling when UE de-registers from different PLMNs over different access in a 5G system in accordance with one novel aspect.

FIG. 6 illustrates a fourth embodiment of a method for 5G NAS security contexts handling when UE registers to different PLMNs over different access in a 5G system in accordance with one novel aspect.

FIG. 7 is a flow chart of a method for 5G NAS security contexts handling when UE registers to different PLMNs over different access in a 5G system in accordance with one novel aspect.

FIG. 8 is a flow chart of a method for 5G NAS security contexts handling when UE de-registers from different PLMNs over different access in a 5G system in accordance with one novel aspect.

### DETAILED DESCRIPTION

Reference will now be made in detail to some embodiments of the invention, examples of which are illustrated in the accompanying drawings.

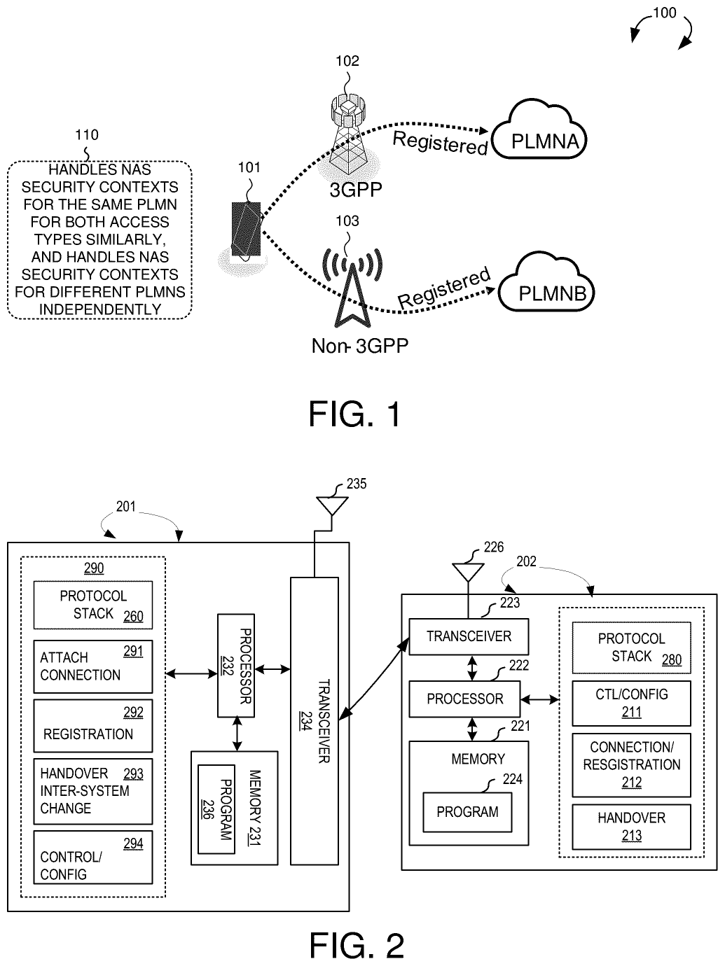

FIG. 1 illustrates an exemplary next generation 5G new radio (NR) network 100 that handles 5G NAS security contexts storage for UE supporting both 3GPP access and non-3GPP access in accordance with one novel aspect. NR network 100 comprises a user equipment UE 101, a 3GPP radio access network (RAN) 102, a non-3GPP RAN 103, a first Public Land Mobile Network (PLMN) (PLMNA), and a second PLMN (PLMNB). A radio access network provides radio access for UE via a radio access technology (RAT), e.g., 3GPP and/or non-3GPP. UE 101 may be equipped with a radio frequency (RF) transceiver or multiple RF transceivers for different application services via different RATs/CNs. UE 101 may be a smart phone, a wearable device, an Internet of Things (IoT) device, and a tablet, etc.

In the core network, an access and mobility function (AMF) serves as termination point for non-access stratum (NAS) security. The purpose of NAS security is to securely deliver NAS signaling messages between UE and AMF in the control plane using NAS security keys and NAS algorithms. The AMF can be collocated with a SEcurity Anchor Function (SEAF) that holds the root key (known as anchor key) for the visited network. For mobility management, the AMF initiates a NAS layer security procedure. During handover, NAS aspects that need to be considered are the possible K_{AMF} change, the possible NAS algorithm change, and the possible presence of a parallel NAS connection. A UE can support multiple records for storing the NAS security context (SC) for multiple registrations over different access types. A UE can also support multiple registrations to different PLMNs over different access types.

For example, UE 101 supports multiple records of NAS security context for multiple registrations (i.e., for registrations to different PLMNs (PLMNA and PLMNB) over 3GPP access and non-3GPP access). In general, there is record#1 and record#2 for 3GPP access and for non-3GPP access. Record#1 of the access type contains security context for the currently registered PLMN over the access (e.g., 5GS NAS security context for the 3GPP access). Record#2 of the access type contains security context of the second access (e.g., the non-3GPP access) in a case the second access is registered in a different PLMN than the first access.

In one example, UE 101 is deregistered and has valid stored 5GS 3GPP access NAS security context for PLMNA from previous registration over 3GPP access, and valid 5GS non-3GPP access NAS security context for PLMNB from previous registration over non-3GPP access. When UE 101 registers to PLMNA over 3GPP access and marks correctly the security context for PLMNA as invalid (in both 3GPP and non-3GPP storages). However, under the current 3GPP specification, the UE marks (incorrectly) the NAS security context for PLMNB as invalid too. Earlier valid 5GS NAS security context for PLMNB is thus discarded. As a result, when the UE initiates registration over non-3GPP access, the UE has to send REGISTRATION message non-protected (plain) (unprotected message is always a security risk) and the network needs to process authentication and security mode control procedures against the UE (which result in unnecessary signaling load and unnecessary power consumption).

In another example, UE 101 supports multiple records of NAS security context for multiple registrations (i.e., for registrations to different PLMNs over 3GPP access and non-3GPP access), and UE 101 is registered in different PLMNs over 3GPP access and non-3GPP access (e.g., in PLMNA over 3GPP access and in PLMNB over non-3GPP access). UE 101 then performs de-registration from PLMNA over 3GPP access. Under the current spec, the UE cannot mark the NAS security context for PLMNA as valid because the UE remains registered in PLMNB over non-3GPP access. However, when the UE attempts registration over 3GPP access, the UE has to send REGISTRATION message non-protected (plain) (unprotected message is always a security risk) and the network needs to process authentication and security mode control procedures against the UE (unnecessary signaling load, unnecessary power consumption).

In accordance with one novel aspect, a method of handling of 5G NAS security context for UEs supporting multiple registrations to different PLMNs over both 3GPP and non-3GPP access types is proposed (110). The UE should handle the NAS security contexts of the same PLMN for different access types similarly, and should handle the NAS security contexts of different PLMNs for different access types independently. If the UE registers to PLMNA over 3GPP then the security contexts of the PLMNA for both 3GPP and non-3GPP are set invalid. If the UE registers to PLMNB over non-3GPP then the security contexts of the PLMNB for both 3GPP and non-3GPP are set invalid. If the UE has been registered in PLMNA over 3GPP and has stored security context for PLMNA and is now deregistered from PLMNA over 3GPP, the security context of the PLMNA becomes valid for both access types. If the UE has been registered in PLMNB over non-3GPP and has stored security context for PLMNB and is now deregistered from PLMNB over non-3GPP, the security context of the PLMNB becomes valid for both access types.

In one embodiment, a UE is being de-registered from a first PLMN over a first access and a second access, and the UE has valid 5GS NAS security contexts of the first PLMN stored for the first access and the second access. The UE is also being de-registered from a second PLMN over the second access, and the UE has valid 5GS NAS security contexts of the second PLMN stored for the first access and the second access. The UE performs a registration to the first PLMN over the first access, and stores and marks the 5GS NAS security contexts of the first PLMN as invalid for the first access and as invalid for the second access. The UE remains de-registered from the second PLMN over the second access, and the UE maintains the stored 5GS NAS security contexts of the second PLMN as valid for the first access and as valid for the second access.

In another embodiment, a UE is registered to a first PLMN over a first access and is registered to a second PLMN over a second access. The UE has 5GS NAS security contexts of the first PLMN stored and marked as invalid for the first access and the second access. The UE also has 5GS NAS security contexts of the second PLMN stored and marked as invalid for the first access and the second access. The UE then deregisters from the first PLMN over the first access and remain registered in the second PLMN over the second access. The UE stores and marks the 5GS NAS security contexts of the first PLMN as valid for the first access and as valid for the second access. The UE maintains the stored 5GS NAS security contexts of the second PLMN as invalid for the first access and as invalid for the second access.

FIG. 2 illustrates simplified block diagrams of a user equipment UE 201 and a network entity 202 in accordance with embodiments of the current invention. Network entity 202 can be a gNB or an AMF or both. Network entity 202 may have an antenna 226, which may transmit and receive radio signals. RF transceiver module 223, coupled with the antenna, may receive RF signals from antenna 226, convert them to baseband signals and send them to processor 222. RF transceiver 223 may also convert received baseband signals from processor 222, convert them to RF signals, and send out to antenna 226. Processor 222 may process the received baseband signals and invoke different functional modules to perform features in network entity 202. Memory 221 may store program instructions and data 224 to control the operations of network entity 202. Network entity 202 may also include a set of functional modules and control circuits, such as protocol stack 260, a control and configuration circuit 211 for control and configure mobility to UE, a connection and registration handling circuit 212 for establish connection and registration with UE, and a handover circuit 213 for sending handover and inter-system change commands to UE.

Similarly, UE 201 has an antenna 235, which may transmit and receive radio signals. RF transceiver module 234, coupled with the antenna, may receive RF signals from antenna 235, convert them to baseband signals and send them to processor 232. RF transceiver 234 may also convert received baseband signals from processor 232, convert them to RF signals, and send out to antenna 235. Processor 232 may process the received baseband signals and invoke different functional modules to perform features in the UE 201. Memory 231 may store program instructions and data 236 to control the operations of the UE 201. UE 201 may also include a set of function modules and control circuits that may carry out functional tasks of the present invention. Protocol stacks 260 comprise Non-Access-Stratum (NAS) layer to communicate with an AMF/SMF/MME entity connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. An attach and connection circuit 291 may attach to the network and establish connection with serving gNB, a registration circuit 292 may perform registration with AMF, a handover handling circuit 293 may perform handover or inter-system change, and a control and configuration circuit 294 for control and configure session and mobility related features.

The various function modules and control circuits may be implemented and configured by software, firmware, hardware, and combination thereof. The function modules and circuits, when executed by the processors via program instructions contained in the memory, interwork with each other to allow the base station and UE to perform embodiments and functional tasks and features in the network. Each module or circuit may comprise a processor (e.g., 222 or 232) together with corresponding program instructions. In one example, the UE handles the security contexts of the same PLMN similarly for both access types. If the UE registers to a PLMN over 3GPP or non-3GPP then the security contexts of the PLMN for both 3GPP and non-3GPP are set invalid. If the UE has been registered in a PLMN over 3GPP or non-3GPP and has stored security context for the PLMN and is now deregistered from the PLMN over 3GPP or non-3GPP, the security context of the PLMN becomes valid for both access types.

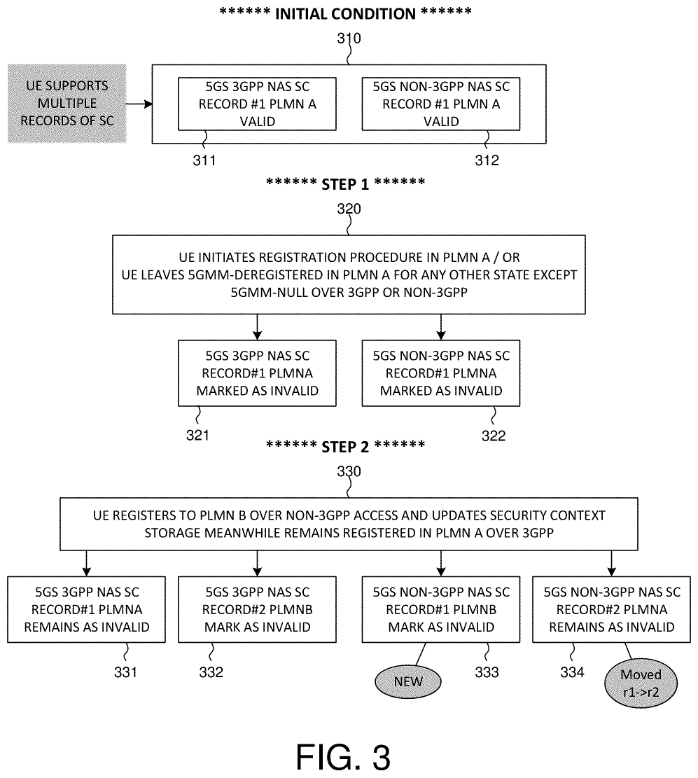

FIG. 3 illustrates a first embodiment of a method for 5G NAS security contexts handling when UE registers to different PLMNs over different access in a 5G system in accordance with one novel aspect. If the UE is 3GPP and non-3GPP capable and been registered in PLMNA having native 5G NAS security context and then get de-registered over both accesses. Under such initial condition 310, the UE has a security context stored as following: EF_{5GS3GPPNSC} (5GS 3GPP Access NAS Security Context) in record#1 contains a 3GPP 5G NAS security context for PLMNA MARKED AS VALID (311), and EF_{5GSN3GPPNSC} (5GS non-3GPP Access NAS Security Context) in record#1 contains a non-3GPP 5G NAS security context for PLMNA MARKED AS VALID (312).

If the UE is capable of registration over both 3GPP access and non-3GPP access, the UE in the state 5GMM-DEREGISTERED over both 3GPP access and non-3GPP access shall mark the 5G NAS security contexts of the 3GPP access and the non-3GPP access as invalid when the UE initiates an initial registration procedure over either 3GPP access or non-3GPP access. In the embodiment of FIG. 3, in STEP1, the UE initiates a registration procedure to PLMNA over either 3GPP access or non-3GPP access, or the UE leaves 5GMM-Degregistered in PLMNA for any other state except 5GMM-NULL over 3GPP or non-3GPP (320). The UE marks the 5GS 3GPP NAS SC for PLMNA in record#1 as invalid (321), and the UE marks the 5GS non-3GPP NAS SC for PLMNA in record#1 as invalid (322). However, the UE should not mark the 5GS NAS SC for PLMNB as invalid. In one novel aspect, if the UE remains de-registered from PLMNB, then the 5GS 3GPP NAS SC for PLMNB and the 5GS non-3GPP NAS SC for PLMNB should remain as valid.

Later on, in STEP2, the UE registers to PLMNB over non-3GPP access and updates the NAS SC meanwhile remains registered in PLMNA over 3GPP (330). The 5GS 3GPP NAS SC for PLMNA is stored in record#1 and remains as invalid (331). The 5GS non-3GPP NAS SC for PLMNA is moved from record#1 to record#2 and remains as invalid (334). The 5GS 3GPP NAS SC for PLMNB is stored in record#2 and marked as invalid (332). The 5GS non-3GPP NAS SC for PLMNB is stored in record#1 and marked as invalid (333). In one novel aspect, the UE should handle the security contexts of the same PLMN over different access types similarly, i.e., if the UE registers to PLMNA over 3GPP access then the security contexts of PLMNA for both 3GPP and non-3GPP are set invalid. If the UE registers to PLMNB over non-3GPP then the security contexts of PLMNB for both 3GPP and non-3GPP are set invalid.

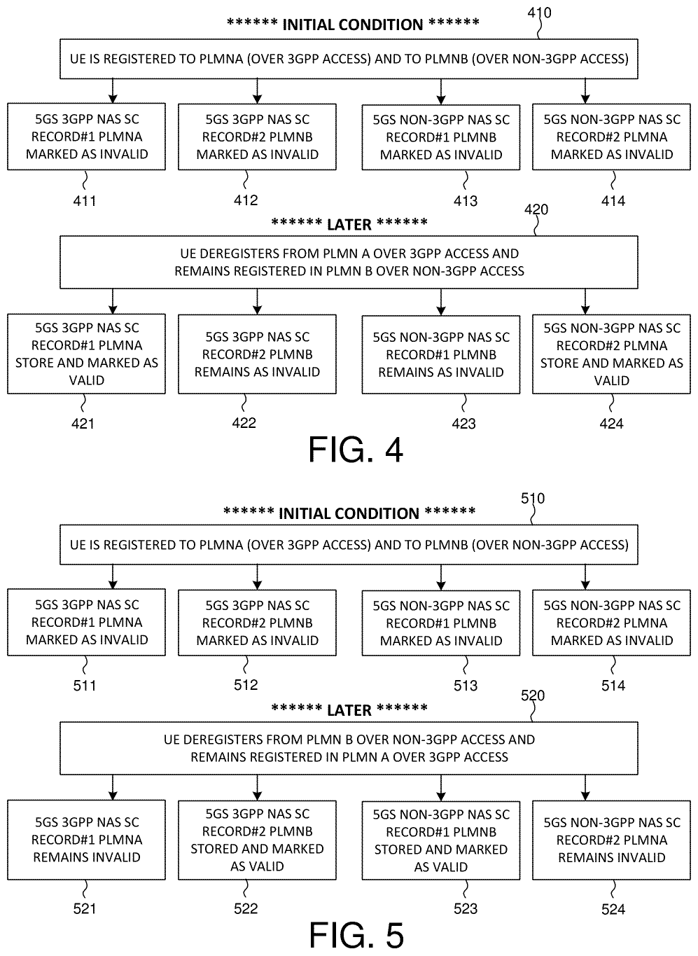

FIG. 4 illustrates a second embodiment of a method for 5G NAS security contexts handling when UE de-registers from different PLMNs over different access in a 5G system in accordance with one novel aspect. Under the initial condition (410), UE is registered to PLMNA over 3GPP access, the UE has a common security context i.e., EF_{5GS3GPPNSC} (5GS 3GPP Access NAS Security Context) stored in record#1, which contains a 3GPP 5G NAS security context for PLMNA MARKED AS INVALID (411), and EF_{5GSN3GPPNSC} (5GS non-3GPP Access NAS Security Context) stored in record#2, which contains a non-3GPP 5G NAS security context for PLMNA MARKED AS INVALID (414). UE is registered to PLMNB over non-3GPP access, the UE has EF_{5GS3GPPNSC} (5GS 3GPP Access NAS Security Context) stored in record#2, which contains a 3GPP 5G NAS security context for PLMNB MARKED AS INVALID (412), and EF_{5GSN3GPPNSC} (5GS non-3GPP Access NAS Security Context) stored in record#1, which contains a non-3GPP 5G NAS security context for PLMNB MARKED AS INVALID (413).

Later on, the UE deregisters from PLMNA over 3GPP access and remains registered in PLMNB over non-3GPP access (420). The 5GS 3GPP NAS SC for PLMNA is stored in record#1 and is marked as valid (421). The 5GS non-3GPP NAS SC for PLMNA is stored in record#2 and also marked as valid (424). The 5GS 3GPP NAS SC for PLMNB is stored in record#2 and remains as invalid (422). The 5GS non-3GPP NAS SC for PLMNB is stored in record#1 and remains as invalid (423). If the UE has been registered in PLMNA over 3GPP and has stored security context for PLMNA and is now deregistered from PLMNA over 3GPP, the security context of the PLMNA becomes valid for both access types, even though the UE remains registered in PLMNB.

FIG. 5 illustrates a third embodiment of a method for 5G NAS security contexts handling when UE de-registers from different PLMNs over different access in a 5G system in accordance with one novel aspect. Under the initial condition (510), UE is registered to PLMNA over 3GPP access, the UE has a common security context i.e., EF_{5GS3GPPNSC} (5GS 3GPP Access NAS Security Context) stored in record#1, which contains a 3GPP 5G NAS security context for PLMNA MARKED AS INVALID (511), and EF_{5GSN3GPPNSC} (5GS non-3GPP Access NAS Security Context) stored in record#2, which contains a non-3GPP 5G NAS security context for PLMNA MARKED AS INVALID (514). The UE is registered to PLMNB over non-3GPP access, the UE has EF_{5GS3GPPNSC} (5GS 3GPP Access NAS Security Context) stored in record#2, which contains a 3GPP 5G NAS security context for PLMNB MARKED AS INVALID (512), and EF_{5GSN3GPPNSC} (5GS non-3GPP Access NAS Security Context) stored in record#1, which contains a non-3GPP 5G NAS security context for PLMNB MARKED AS INVALID (513).

Later on, the UE deregisters from PLMNB over non-3GPP access and remains registered in PLMNA over 3GPP access (520). The 5GS 3GPP NAS SC for PLMNA is stored in record#1 and remains as invalid (521). The 5GS non-3GPP NAS SC for PLMNA is stored in record#2 and remains as invalid (524). The 5GS 3GPP NAS SC for PLMNB is stored in record#2 and is marked as valid (522). The 5GS non-3GPP NAS SC for PLMNB is stored in record#1 and is marked as valid (523). If the UE has been registered in PLMNB over non-3GPP and has stored security context for PLMNB and is now deregistered from PLMNB over non-3GPP, the security context of the PLMNB becomes valid for both access types, even though the UE remains registered in PLMNA.

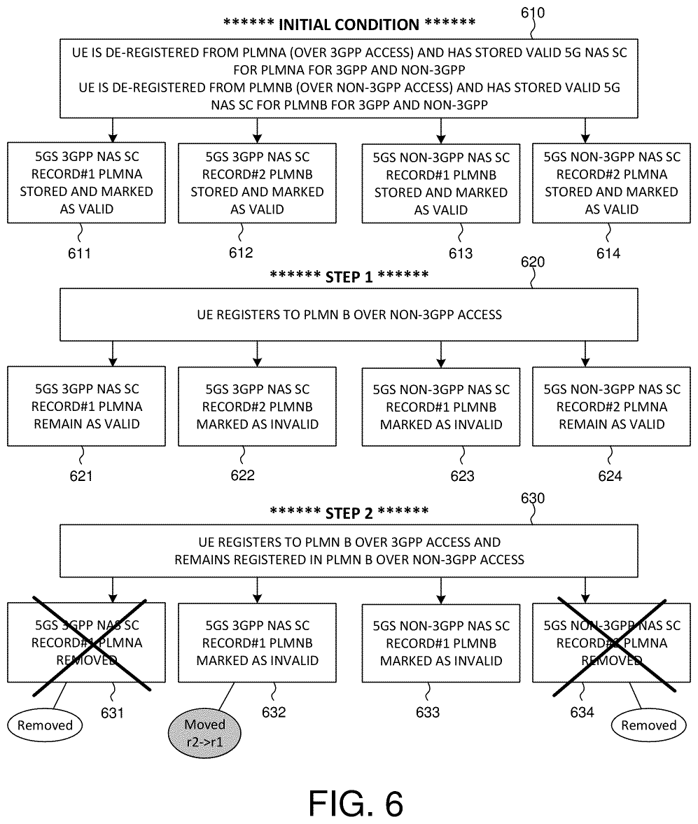

FIG. 6 illustrates a fourth embodiment of a method for 5G NAS security contexts handling when UE registers to different PLMNs over different access in a 5G system in accordance with one novel aspect. If the UE is 3GPP and non-3GPP capable and been registered in PLMNA/PLMNB having native 5G NAS security context and then get de-registered over both accesses. Under such initial condition (610), the UE has security contexts stored as following: EF_{5GS3GPPNSC} (5GS 3GPP Access NAS Security Context) in record#1 contains a 3GPP 5G NAS security context for PLMNA MARKED AS VALID (611), and EF_{5GSN3GPPNSC} (5GS non-3GPP Access NAS Security Context) in record#2 contains a non-3GPP 5G NAS security context for PLMNA MARKED AS VALID (614), EF_{5GS3GPPNSC} (5GS 3GPP Access NAS Security Context) in record#2 contains a 3GPP 5G NAS security context for PLMNB MARKED AS VALID (612), and EF_{5GSN3GPPNSC} (5GS non-3GPP Access NAS Security Context) in record#1 contains a non-3GPP 5G NAS security context for PLMNB MARKED AS VALID (613).

If the UE is capable of registration over both 3GPP access and non-3GPP access, the UE in the state 5GMM-DEREGISTERED over both 3GPP access and non-3GPP access shall mark the 5G NAS security contexts of the 3GPP access and the non-3GPP access as invalid when the UE initiates an initial registration procedure over either 3GPP access or non-3GPP access. In FIG. 6, in STEP1 (620), the UE registers to PLMNB over non-3GPP access and updates the NAS SC meanwhile remains de-registered in PLMNA over 3GPP. The 5GS 3GPP NAS SC for PLMNA is stored in record#1 and remains as valid (621). The 5GS non-3GPP NAS SC for PLMNA is stored in record#2 and remains as valid (624). The 5GS 3GPP NAS SC for PLMNB stored in record#2 is marked as invalid (622). The 5GS non-3GPP NAS SC for PLMNB is stored in record#1 and marked as invalid (623).

Later on, in STEP2 (630), the UE registers to PLMNB over 3GPP access and remains registered in PLMNB over non-3GPP access. The 5GS 3GPP NAS SC for PLMNA was stored in record#1 and now removed (631). The 5GS non-3GPP NAS SC for PLMNA was stored in record#2 and now removed (634). The 5GS 3GPP NAS SC for PLMNB was stored in record#2 and moved to record#1 and marked as invalid (632). The 5GS non-3GPP NAS SC for PLMNB is in record#1 is marked as invalid (633).

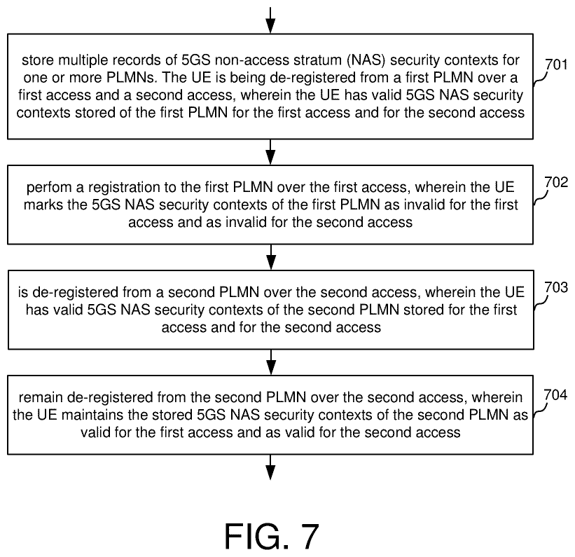

FIG. 7 is a flow chart of a method for 5G NAS security contexts handling when UE registers to different PLMNs over different access in a 5G system in accordance with one novel aspect. In step 701, a UE stores multiple records of 5GS non-access stratum (NAS) security contexts for one or more PLMNs, wherein the UE is being de-registered from a first PLMN over a first access and a second access, wherein the UE has valid 5GS NAS security contexts of the first PLMN stored for the first access and for the second access. In step 702, the UE performs a registration to the first PLMN over the first access, wherein the UE marks the 5GS NAS security contexts of the first PLMN as invalid for the first access and as invalid for the second access. In step 703, the UE is de-registered from a second PLMN over the second access, wherein the UE has valid 5GS NAS security contexts of the second PLMN stored for the first access and for the second access. In step 704, the UE remains de-registered from the second PLMN over the second access, wherein the UE maintains the stored 5GS NAS security contexts of the second PLMN as valid for the first access and as valid for the second access.

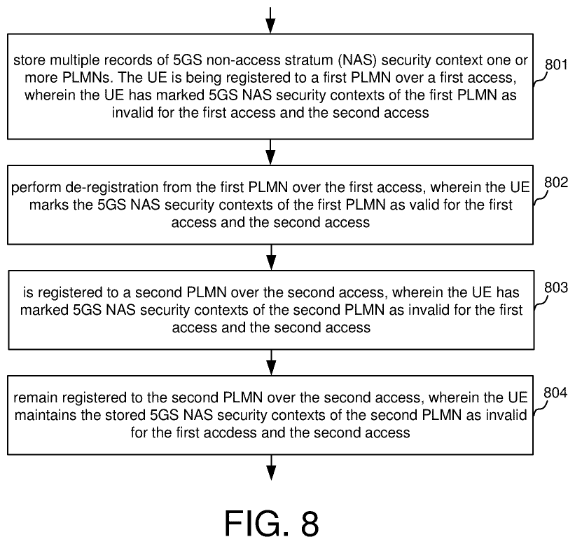

FIG. 8 is a flow chart of a method for 5G NAS security contexts handling when UE de-registers from different PLMNs over different access in a 5G system in accordance with one novel aspect. In step 801, a UE stores multiple records of 5GS non-access stratum (NAS) security context for one or more PLMNs, wherein the UE is being registered to a first PLMN over a first access, wherein the UE has marked 5GS NAS security contexts of the first PLMN as invalid for the first access and as invalid for the second access. In step 802, the UE performs de-registration from the first PLMN over the first access, wherein the UE marks the 5GS NAS security contexts of the first PLMN as valid for the first access and as valid for the second access. In step 803, the UE is registered to a second PLMN over the second access, wherein the UE has marked 5GS NAS security contexts of the second PLMN as invalid for the first access and as invalid for the second access. In step 804, the UE remains registered to the second PLMN over the second access, wherein the UE maintains the stored 5GS NAS security contexts of the second PLMN as invalid for the first access and as invalid for the second access.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1. A method, comprising:
storing multiple records of 5GS non-access stratum (NAS) security contexts for one or more PLMNs by a user equipment (UE), wherein the UE is being de-registered from a first PLMN over a first access and a second access, wherein the UE has valid 5GS NAS security contexts of the first PLMN stored for the first access and for the second access; and
performing a registration to the first PLMN over the first access, wherein the UE marks the 5GS NAS security contexts of the first PLMN as invalid for the first access and as invalid for the second access.

2. The method of claim 1, further comprising:
being de-registered from a second PLMN over the second access, wherein the UE has valid 5GS NAS security contexts of the second PLMN stored for the first access and for the second access; and
remain de-registered from the second PLMN over the second access while the UE is registered to the first PLMN over the first access, wherein the UE maintains the stored 5GS NAS security contexts of the second PLMN as valid for the first access and as valid for the second access.

3. The method of claim 1, wherein the UE manages a first record and a second record for the first access, and wherein the UE also manages a first record and a second record for the second access.

4. The method of claim 3, wherein the 5GS NAS security context of the first PLMN for the first access is stored in the first record for the first access, and the 5GS NAS security context of the first PLMN for the second access is stored in the second record for the second access.

5. The method of claim 3, wherein the 5GS NAS security context of the second PLMN for the second access is stored in the first record for the second access, and the 5GS NAS security context of the second PLMN for the first access is stored in the second record for the first access.

6. A user equipment (UE), comprising:
multiple records for storing 5GS non-access stratum (NAS) security contexts for one or more PLMNs, wherein the UE is being de-registered from a first PLMN over a first access and a second access, wherein the UE has valid 5GS NAS security contexts of the first PLMN stored for the first access and for the second access; and
a registration circuit of the UE that performs a registration to the first PLMN over the first access, wherein the UE marks the 5GS NAS security contexts of the first PLMN as invalid for the first access and as invalid for the second access.

7. The UE of claim 6, wherein the UE is de-registered from a second PLMN over the second access, wherein the UE has valid 5GS NAS security contexts of the second PLMN stored for the first access and for the second access, and wherein the UE maintains the stored 5GS NAS security contexts of the second PLMN as valid for the first access and as valid for the second access when the UE is registered to the first PLMN over the first access.

8. The UE of claim 6, wherein the UE manages a first record and a second record for the first access, and wherein the UE also manages a first record and a second record for the second access.

9. The UE of claim 6, wherein the UE performs a registration to the second PLMN over the second access, wherein the UE marks the 5GS NAS security contexts of the second PLMN as invalid for the second access and as invalid for the first access.

10. The UE of claim 9, wherein the UE marks 5GS security contexts in a first record of the first access for the first PLMN as invalid and the 5GS security contexts in a second record of the first access for the second PLMN as invalid, and marks the 5GS security contexts in the first record of the second access for the second PLMN as invalid and the 5GS security contexts in the second record of the second access for the first PLMN as invalid.

11. A method, comprising:
storing multiple records of 5GS non-access stratum (NAS) security context for one or more PLMNs by a user equipment (UE), wherein the UE is being registered to a first PLMN over a first access, wherein the UE has marked 5GS NAS security contexts of the first PLMN as invalid for the first access and as invalid for the second access; and
performing de-registration from the first PLMN over the first access, wherein the UE marks the 5GS NAS security contexts of the first PLMN as valid for the first access and as valid for the second access.

12. The method of claim 11, further comprising:
being registered to a second PLMN over the second access, wherein the UE has marked 5GS NAS security contexts of the second PLMN as invalid for the first access and as invalid for the second access; and
remain registered to the second PLMN over the second access, wherein the UE maintains the stored 5GS NAS security contexts of the second PLMN as invalid for the first access and as invalid for the second access.

13. The method of claim 11, wherein the UE manages a first record and a second record for the first access, and wherein the UE also manages a first record and a second record for the second access.

14. The method of claim 13, wherein the 5GS NAS security context of the first PLMN for the first access is stored in the first record for the first access, and the 5GS NAS security context of the first PLMN for the second access is stored in the second record for the second access.

15. The method of claim 13, wherein the 5GS NAS security context of the second PLMN for the second access is stored in the first record for the second access, and the 5GS NAS security context of the second PLMN for the first access is stored in the second record for the first access.

16-20. (canceled)
